(19) United States
(12) Patent Application Publication
(10) Pub. No.: US 2013/0146557 A1
(43) Pub. Date: Jun. 13, 2013

(54) Mobile Machine, in Particular Truck Crane

(71) Applicant: LIEBHERR-WERK EHINGEN GMBH, Ehingen/Donau (DE)

(72) Inventor: Hans-Dieter Willim, Ulm-Unterweiler (DE)

(73) Assignee: LIEBHERR-WERK EHINGEN GMBH, Ehingen/Donau (DE)

(21) Appl. No.: 13/686,004

(22) Filed: Nov. 27, 2012

(30) Foreign Application Priority Data
Nov. 29, 2011 (DE) 10 2011 119 654.8

(51) Int. Cl. B66C 23/78; B66C 23/90; B66C 23/80

(52) U.S. Cl. CPC B66C 23/78; B66C 23/80; B66C 23/90
USPC 212/278; 212/301

(57) ABSTRACT

The present invention relates to a mobile machine, in particular a truck crane, with an undercarriage on which extendable sliding beams located opposite each other relative to its middle axis are arranged, which include extendable supporting feet, and with an uppercarriage to which a boom, preferably a telescopic boom, is luffably articulated. According to the invention, at least one sliding beam on one side of the middle axis is designed such that the extendable supporting foot can be extended further away from the middle axis than the other supporting feet.

This invention relates to a mobile machine, in particular a truck crane, according to the generic part of claim 1.

Mobile machines which include an uppercarriage rotatably mounted on an undercarriage, to which uppercarriage a boom is luffably articulated, usually include outriggers, in order to ensure greater safety against tilting of the entire machine during the operation of the machine.

In the prior art, different solutions are described.

WO 2011/072523 A1 describes a telescopable multistage outrigger which at its outer end includes a support cylinder. At the respective sliding beams a plurality of outriggers are arranged.

From CN 101717039 A outriggers with sliding beams are known, in which the receptacle for the support cylinder is shiftably mounted. In this way, a suitable positioning of the supporting plate carried by the support cylinder should be achieved.

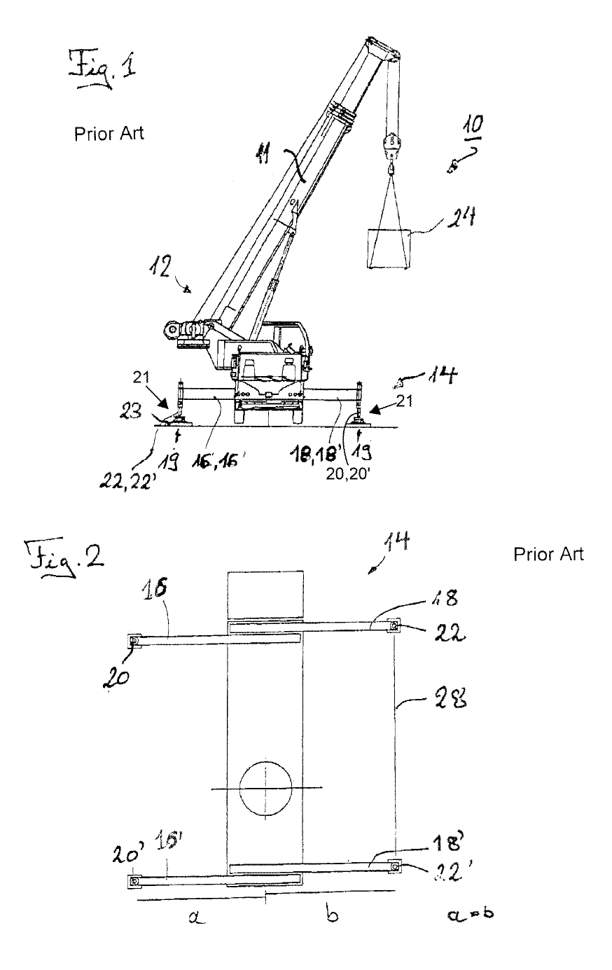

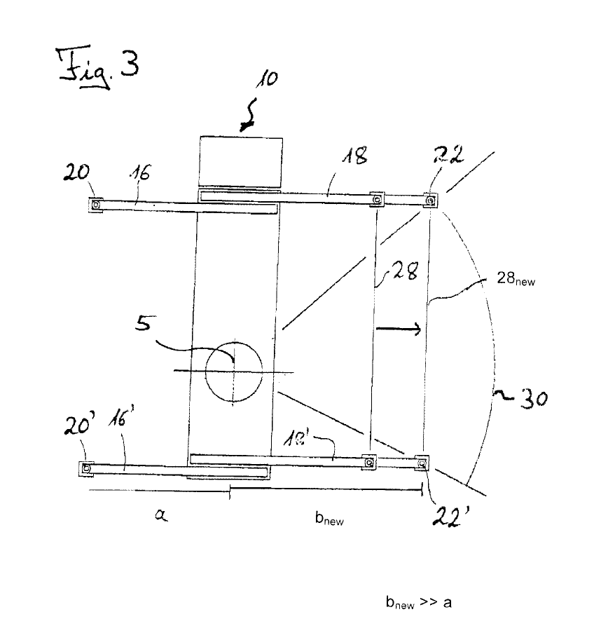

For a greater stability it must be accepted in principle that comparatively large-size outriggers with corresponding sliding beams and supporting feet are provided. Since they usually are carried along with the machine, the same usually lead to an increase in the total weight of the machine. Thus, there is a conflict between the greater stability due to correspondingly dimensioned outriggers on the one hand and an undesired increase in weight of the entire machine on the other hand. In the outriggers of machines as they are known from the prior art, it is already possible in principle to asymmetrically extend the outrigger in use of the machine in dependence on the respective space conditions. When extending the respective sliding beams, which always have the same size on all sides, the respective space conditions obtained each are taken into account. The outriggers, however, are designed such that they can be extended equally far. In the extended condition, the tilt edges are determined (cf. FIG. 2).

It is the object of the present invention to solve the conflict between a greater stability and the necessary saving of weight by an optimized design of the outrigger.

According to the invention, a mobile machine with an undercarriage, on which extendable sliding beams are arranged opposite each other relative to its middle axis, which include extendable supporting feet, and with an uppercarriage to which a boom is luffably articulated, therefore is designed such that at least one sliding beam on one side of the middle axis is designed such that the extendable supporting foot can be extended further away from the middle axis than the other supporting feet.

Accordingly, not all sliding beams are dimensioned equally large. Merely the at least one sliding beam extendable further, which in a region in which it is extended ensures a higher stability, is dimensioned correspondingly large. The other sliding beams can be dimensioned correspondingly smaller and thus save weight.

The invention is based on the finding that during operation of the crane the uppercarriages of machines and in particular the uppercarriages of truck cranes are not always rotated by 360° under a maximum load moment. Here, it is generally sufficient to provide for a particularly high safety against tilting in a defined range of rotation of the uppercarriage. In this range, the outrigger, i.e. the sliding beam with the corresponding supporting foot, is dimensioned correspondingly larger in accordance with the invention.

Preferred aspects of the invention can be taken from the sub-claims following the main claim.

Accordingly, all supporting feet located on one side advantageously may be extendable further away from the middle axis than the supporting feet located on the opposite side of the middle axis. It thus is ensured that during operation of the crane the uppercarriage can work under a maximum torque on the side of the extended supporting feet.

According to a particularly preferred aspect of the invention, at least one sliding beam is designed longer than the other sliding beams. One sliding beam can include at least one telescopic section more than the remaining sliding beams.

According to another preferred solution, an extension may be attachable, preferably boltable to at least one sliding beam, at whose one end an element for introducing force into the ground is arranged.

This element for introducing force into the ground preferably can actively be adjustable by adjusting means, preferably a piston-cylinder unit.

According to an alternative design variant of the invention, the element for introducing force into the ground can, however, also be passively adjustable or fixed.

According to an other preferred aspect of the invention, the telescopic sections can shiftably be mounted relative to each other via rollers at least during extension, wherein these rollers can be brought out of engagement under load such that the support with respect to the next larger telescopic section is effected by at least one bearing block. This solution is already known in principle from WO 2011/067856 A1, in which a support of the telescopic sections of a telescopic boom is effected with rollers. When the telescopic boom is slightly loaded, for example during telescoping, the corresponding rolls or rollers are in engagement. When the telescopic boom is loaded more, however, for example during operation of the crane by lifting a load, the rollers are brought out of engagement and a correspondingly large bearing surface performs the support.

In accordance with another particularly preferred design variant, analogous to the teaching of EP 0 779 237 B1 of the same applicant, there is used an overload protection means with a means measuring the slewing angle of the boom, whose signals can be supplied to a processing unit of the overload protection means, in which the overload protection means generates a warning signal and/or stops the crane operation, when the crane approaches or exceeds a limit endangering the stability, wherein there is provided a monitoring means detecting the support condition of the sliding beams, which can supply signals corresponding to the respective support condition to the overload protection means, so that from the respective signals of the slewing angle and the support condition of the individual sliding beams the stability of the standing square can be determined.

Finally, in accordance with the present invention, the 360° slewing angle range of the boom preferably is divided into several slewing angle ranges, wherein for each of these slewing angle ranges a uniform admissible boom moment, which corresponds to the maximum admissible boom moment for this angular range, can be put into a table from which these values can be read out for processing.

Further features, details and advantages of the invention will be explained with reference to an exemplary embodiment illustrated in the drawing, in which:

FIG. 1: shows an overall view of the truck crane in working position according to the prior art,

FIG. 2: shows the top view of a part of the truck crane of FIG. 1 in a simplified representation according to the prior art,

FIG. 3: shows a representation according to FIG. 2 corresponding to the design according to an exemplary embodiment of the invention,

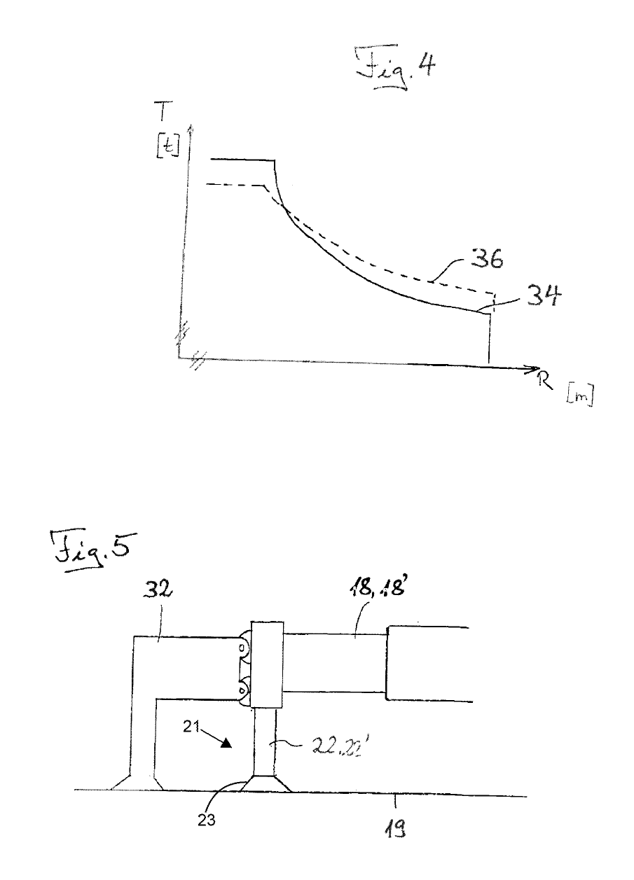

FIG. 4: shows a load chart in which the sustainable load is plotted in tons over the boom radius in meters, and

FIG. 5: shows a detail representation of a part of an outrigger according to a second design variant of the invention.

FIG. 1 shows a truck or mobile crane 10 which in the exemplary embodiment shown here includes wheels. In the same way, however, tracklaying vehicles can also be used. The truck crane 10 includes an undercarriage 14 and an uppercarriage 12 rotatably arranged on the same. On the uppercarriage a telescopic boom 11 is luffably arranged in a known way. Via the telescopic boom 11, a load 24 can be lifted in a known manner.

In the exemplary embodiment shown here, the undercarriage 14 of the truck crane 10 includes four sliding beams 16, 16′ and 18, 18′.

In the embodiment according to the prior art as shown in FIGS. 1 and 2, the sliding beams 16, 16′ and 18, 18′ are identically constructed in principle, so that they in particular have the same dimensions. At the respective end of the sliding beams 16, 16′ and 18, 18′ support cylinders 20, 20′ and 22, 22′ are mounted, at whose ends base plates 23 each are arranged. The corresponding sliding beams 16, 16′ and 18, 18′ are extendable to the same length, which in the representation of FIG. 2 is represented by the equal distances a and b. In this representation, the sliding beams are extended to their maximum extended length. Thus, a tilt edge 28 is obtained on both sides, which in FIG. 2 is only shown on one side.

The development of the invention is depicted in the schematic representation according to FIG. 3. Here as well, four sliding beams 16, 16′ and 18, 18′ again are provided. Here, however, the sliding beams 18, 18′ on one side are designed such that they can move the support cylinders 22, 22′ and hence the point of the introduction of force into the ground 19 further away from the longitudinal axis 5 of the truck crane 10. The tilt edge 28 new thereby is shifted and the maximum load moment thus is increased for large outreaches on the corresponding side on which the sliding beams are designed longer. In the slewing range 30 according to FIG. 3, the boom hence is able to handle comparatively higher loads.

In terms of control, the load moment limitation of the truck crane 10 can be designed corresponding to the truck crane according to EP 0779237 B1. Accordingly, an overload protection means can be provided with a means measuring the slewing angle of the boom, whose signals can be supplied to a processing unit of the overload protection means. The overload protection means generates a warning signal and/or stops the crane operation, when the truck crane 10 approaches or exceeds a limit endangering the stability, wherein a monitoring means detecting the support condition of the sliding beams 18, 18′ is provided, which can supply signals corresponding to the respective support condition to the overload protection means, so that from the respective signals of the slewing angle and the support condition of the individual sliding beams 18, 18′ the stability of the standing square can be determined.

The maximum admissible lifting capacity of a mobile crane 10 now is composed of various criteria. With large outreaches, the tilt stability, as it has been discussed above, is the limiting criterion. With smaller outreaches, however, the failure of a crane component is the load-limiting quantity.

The support cylinders 20, 20′ and 22, 22′ introduce the entire weight force of the truck crane 10 and the load 24 into the ground 19. Since the distance bnew now is decisive for the moment to be transmitted from the sliding beams 18, 18′, certain components are loaded more. What is particularly worth mentioning in this connection is the clamping point of telescopable sliding beams 18, 18′. Hence it follows that the load charts must be revised due to the higher sustainable load.

In the slewing range 30 according to FIG. 3, a new load chart with increased maximum load moment accordingly is employed for large outreaches.

In FIG. 4 this is shown qualitatively, wherein FIG. 4 shows the lifting capacity T in tons on the ordinate and the boom radius R in meters on the abscissa. The continuous curve 34 represents the lifting capacity with symmetrical support conditions, as they are known in the prior art. The dashed curve 36, on the other hand, shows the lifting capacity with asymmetrical support corresponding to the present invention.

In principle, the asymmetrical support according to the present invention can be realized in various ways. On the one hand, extensions 32 each can be bolted to the existing sliding beams 18 and 18′, as is shown in FIG. 5. At its ends, this extension includes an element for introducing the force into the ground 19. This element can be of the active type, for example via hydraulic cylinders, but also of the passive type (as shown here in FIG. 5). In the passive design of the element, as it is shown in FIG. 5, the support cylinder 22, 22′ maintains its function in the assembly process. The truck crane 10 is lifted by the support cylinders 20, 20′ and 22, 22′. In this condition, the extensions 32 can be attached by the truck crane 10 itself. Subsequently, a mechanical adjustment of the supporting height possibly can be made at the extensions 32. Subsequently, the support cylinders 20, 20′ and 22, 22′ are retracted, until the mobile crane 10 is supported by the two extensions 32 and the support cylinders 20, 20′ and 22, 22′. Alternatively, it would also be possible that the support cylinders 22, 22′ partly remain on the ground and also transmit a supporting force. This solution might be regarded as an inexpensive, simple and light-weight possibility. It can also be retrofitted easily.

In accordance with another non-illustrated design variant, however, telescopable sliding beams 16, 16′ can also be used on the one side with one section less than on the other side, namely the side of the sliding beams 18, 18′. Telescoping the further sliding beam tube with the sliding beams 18, 18′ can be effected mechanically by pulling out or also by a drive, e.g. a hydraulic cylinder.

In a manner not shown here in detail, the respective sections of telescopable sliding beams 16, 16′ or 18, 18′ can be also be pulled out manually. For this purpose, the individual sections advantageously are shiftably supported by roller bearings, wherein the roller bearings can be formed corresponding to the teaching of WO 2011/067856 A1. The rollers can be designed such that with a flux of force in the supported condition they are short-circuited. This can advantageously be effected via resilient elements, which is not shown in detail in the drawing.

1. A mobile machine, comprising:
an undercarriage with extendable sliding beams arranged thereon, the sliding beams located opposite each other relative to a middle axis of the undercarriage, each sliding beam including an extendable supporting foot; and
an uppercarriage with a boom luffably articulated thereto;
wherein the supporting foot of at least one sliding beam on one side of the middle axis is extendable further away from the middle axis than the other supporting feet.

2. The mobile machine according to claim 1, wherein all supporting feet located on one side of the middle axis are extendable further away from the middle axis than those on the opposite side of the middle axis.

3. The mobile machine according to claim 2, wherein at least one sliding beam is longer than the other sliding beams.

4. The mobile machine according to claim 2, wherein the sliding beams comprise telescopic sections, and at least one sliding beam has at least one telescopic section more than the remaining sliding beams.

5. The mobile machine according to claim 4, further comprising an extension attachable to at least one sliding beam, wherein an element for introducing force into the ground is arranged at one end of the extension.

6. The mobile machine according to claim 5, wherein the element for introducing force into the ground is actively adjustable by an adjusting element.

7. The mobile machine according to claim 5, wherein the element for introducing force into the ground is passively adjustable.

8. The mobile machine according to claim 4, wherein the telescopic sections are shiftably mounted relative to each other via rollers at least during extension, and wherein the rollers are unengageable under load when support for a next larger telescopic section is effected by at least one bearing block.

9. The mobile machine according to claim 1, further comprising:
an overload protection element, the overload protection element comprising an element measuring a slewing angle of the boom and supplying signals to a processing unit of the overload protection element, the overload protection element generating a warning signal and/or stopping operation of the mobile machine when the mobile machine approaches or exceeds a limit endangering its stability; and
a monitoring element detecting an extended condition of the sliding and supplying signals corresponding to a respective support condition to the overload protection element;
wherein a determination of the stability of the mobile machine by the overload protection element is based on respective signals of the slewing angle and the support condition of the individual sliding beams.

10. The mobile machine according to claim 9, wherein a 360° slewing angle range of the boom is divided into several slewing angle ranges, and wherein for each of these slewing angle ranges a uniform admissible boom moment, which corresponds to a maximum admissible boom moment for that range, is stored in a table from which values can be read out for processing.

11. The mobile machine according to claim 1, wherein the mobile machine is a truck crane.

12. The mobile machine according to claim 1, wherein the boom is a telescopic boom.

13. The mobile machine according to claim 5, wherein the extension is bolted to the at least one sliding beam.

14. The mobile machine according to claim 6, wherein the adjusting element is a piston cylinder unit.

15. A truck crane, comprising:
an undercarriage with extendable sliding beams arranged thereon, each sliding beam including an extendable supporting foot, the supporting foot of at least one sliding beam on one side of the middle axis extending further away from a middle axis of the undercarriage than the other supporting feet; and
an uppercarriage with a telescopic boom luffably articulated thereto; and
an overload protection element determining a stability of the crane based on a slewing angle and a support condition of the individual sliding beams.

16. The truck crane according to claim 15, wherein the sliding beams are located opposite each other relative to the middle axis of the undercarriage, and wherein all supporting feet located on one side of the middle axis are extendable further away from the middle axis than those on the opposite side of the middle axis.

17. The truck crane according to claim 16, wherein at least one sliding beam is longer than the other sliding beams.

18. The truck crane according to claim 17, wherein the sliding beams comprise telescopic sections shiftably mounted relative to each other via rollers at least during extension, and wherein at least one sliding beam has at least one telescopic section more than the remaining sliding beams.

19. The truck crane according to claim 18, further comprising an extension attachable to at least one sliding beam, wherein an adjustable element for introducing force into the ground is arranged at one end of the extension.

20. The truck crane according to claim 15, wherein a 360° slewing angle range of the boom is divided into several slewing angle ranges, and wherein for each of these slewing angle ranges a uniform admissible boom moment, which corresponds to a maximum admissible boom moment for that range, is stored in a table from which values can be read out for processing.
